(19) United States
(12) Patent Application Publication
(10) Pub. No.: US 2016/0109107 A1
(43) Pub. Date: Apr. 21, 2016

(54) COOLING SYSTEM FOR HORTICULTURAL LIGHTING

(71) Applicant: Once Innovations, Inc., Plymouth, MN (US)

(72) Inventor: Zdenko Grajcar, Orono, MN (US)

(21) Appl. No.: 14/883,710

(22) Filed: Oct. 15, 2015

Related U.S. Application Data
(60) Provisional application No. 62/064,028, filed on Oct. 15, 2014.

(51) Int. Cl. F21V 29/57; F21V 29/58; A01G 7/04; F21V 29/71

(52) U.S. Cl. CPC F21V 29/57; F21V 29/71; F21V 29/59; A01G 7/045; F21Y 2101/02

(57) ABSTRACT

A lighting system for an incubation chamber used to house and incubate a plurality of plants. The lighting system includes a lighting device that has a heatsink with openings for a conduit disposed therethrough. A conduit is disposed through the heat sink and fluid is pumped through the conduit from a pump so that heat from the heatsink transfers to the fluid that is then conveyed remotely for use in the horticultural facility housing the incubation chamber.

### CLAIM OF PRIORITY

This patent application is based upon and claims the benefit of priority of U.S. Provisional Patent Application Ser. No. 62/064,028, entitled “Cooling System for Horticultural Lighting,” filed on Oct. 15, 2014, which is hereby incorporated by reference herein in its entirety.

### BACKGROUND

Plants are predominantly grown outdoors with sunlight providing the main source of light for each plant. Still, as society continues to advance and urban sprawl continues, less and less farmland exists, not just within the U.S. but world-wide. In general the amount of family farms and farmland in general continues to shrink. The family farm is thus slowly being phased out by large corporate farming.

Corporate farms strive on efficiency and getting the most out of their land and crops. They pack as much crop as possible onto their land and then will use chemically engineered seed, fertilizer and pesticide to give them the best chance of producing a bountiful crop. Still, even the corporate farmers are reliant on weather and prone to natural disasters such as fire or flooding.

Over the years, indoor greenhouses have been used to house and grow plants. Often greenhouses would have a glass ceiling, still depending on sunlight to provide photosynthesis. Then greenhouses began using incandescent or artificial lighting indoors. Hydroponic systems also have grown in more prevalence over the last decade as individuals and companies are beginning to see value in moving plant growing activities indoors, away from the unpredictable weather and where planting can occur all year long.

As time has progressed, indoor horticultural growing systems have progressed as companies have desired greater efficiencies in growing their plants. Companies have begun to understand the importance of lighting on the plant and providing wavelengths of light that the sun provides and incandescent lighting cannot. Lighting for these incubators is typically hung from the ceiling and directed at the individual plants.

A problem in the art exists in that incandescent light does not provide the wavelength of light that the sun provides and as a result, other sources of light are required to provide spectrum specific or colored lighting. Light emitting diode (LED) lighting assemblies are often used as a light source that is able to provide monochromatic light of different spectrum, based on the inherent properties of LEDs. However, complex circuitry is required to drive the LEDs such that the LED based lighting device produces such light. However, a drawback is presented in that this circuitry produces a tremendous amount of heat.

Typically to address heat within an LED lighting device a heat sink is provided that draws heat away from the circuitry and into the ambient air. This prevents the heat from damaging the circuitry and LEDs associated with the LED lighting device. As a result LED manufactures strive to eliminate circuitry to eliminate heat produced by the LED lighting device and to provide efficient heat sinks that properly dissipate heat. Usually a well manufactured LED lighting device will be warm to the touch but not hot enough to burn an individual. For residential use, this type of heat sinking is satisfactory. However, in a controlled environment such as a facility used to incubate plants, ensuring the plants are being raised in an optimum environment is vital to maximizing plant growth. As a result, the heat created by the LED lighting devices within a closed chamber incubator must be accounted for. In particular, excess heat can be detrimental to plant life and cause a reduction in plant size and well-being. Consequently such incubation chambers must be climate controlled to ensure the excess heat does not affect the plant life, resulting in additional unneeded electricity costs.

### OVERVIEW

Therefore the principle object of the present invention is to provide a lighting system that efficiently provides light for plants in an indoor environment.

This invention relates to horticultural lighting. More specifically this invention relates to a cooling system for horticultural lighting. An object of the present invention is to provide a lighting system designed to facilitate climate control of an enclosed area. These and other objects, features and advantages will become apparent from the rest of the specification and claims.

An example embodiment includes a lighting system for horticultural lighting within an incubation chamber used to house and incubate a plurality of plants grown. Lighting devices are and a watering system are provided within the incubation chamber to recreate an outdoor environment for the plants. The lighting device is positioned above the plurality of plants so that light is received by the plants to assist in photosynthesis. The lighting device includes a heatsink that has openings for receiving a conduit therethrough such that fluid can flow through the conduit and retain heat from the heat sink and add it to the fluid. In this manner the fluid is heated and heat is conveyed away from the heatsink and plants. The heated fluid is then utilized for other purposes within the horticultural growing facility housing the incubation chamber.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side plan view of a horticultural growing facility;

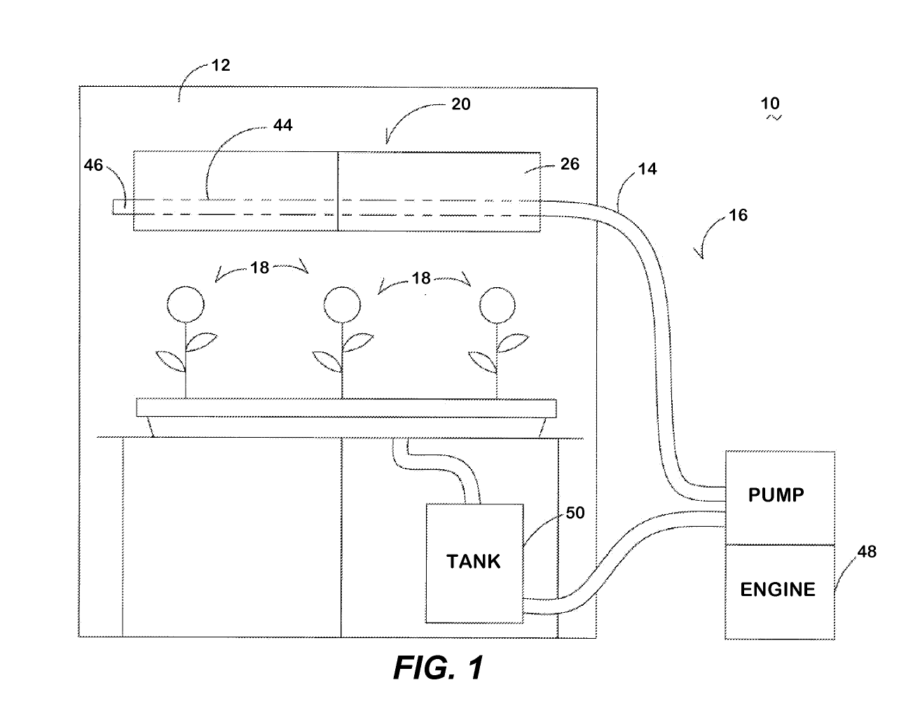

FIG. 2 is a perspective view of a lighting device without a conduit;

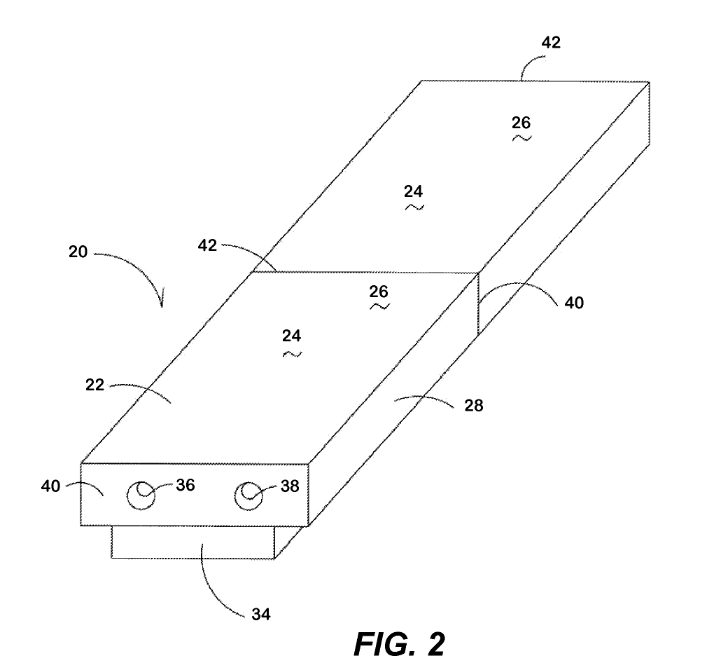

FIG. 3 is a perspective view of a lighting device;

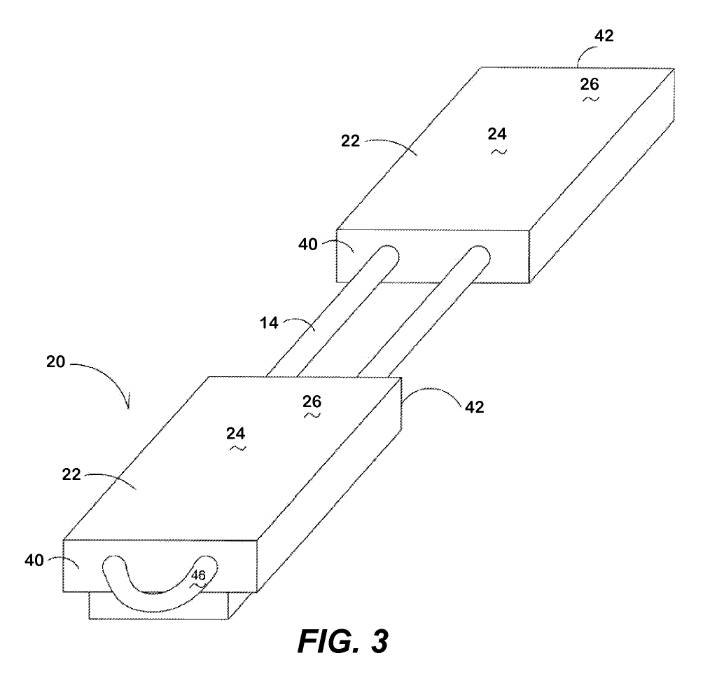

FIG. 4 is a bottom plan view of a lighting device.

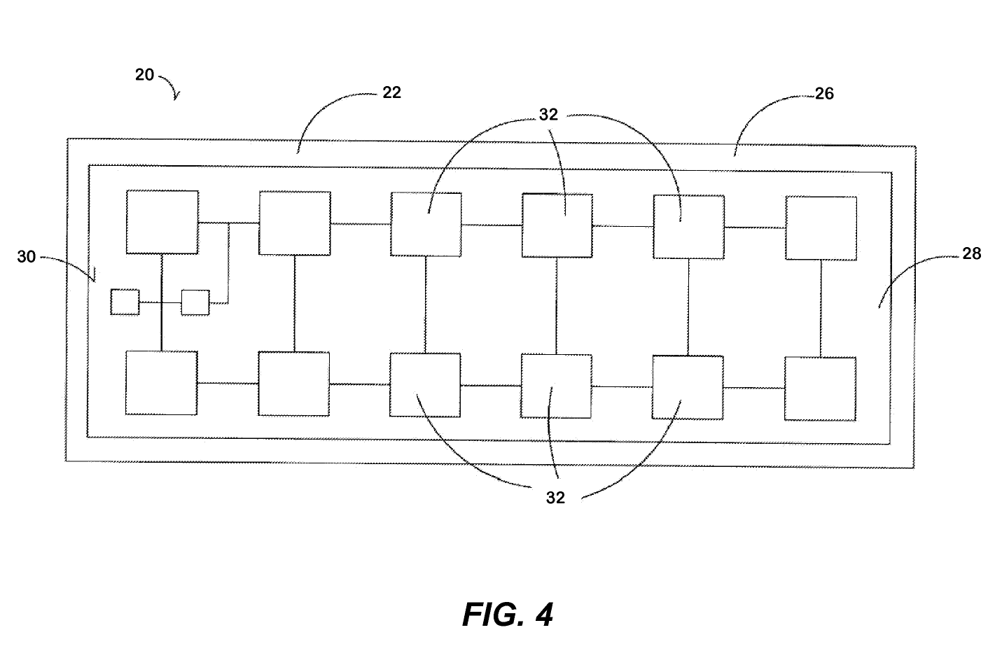

### DETAILED DESCRIPTION OF A PREFERRED EMBODIMENT OF THE INVENTION

The figures show a horticultural growing facility 10 having a plurality of incubation chambers 12. The incubation chambers 12 are closed systems or rooms that are accessible by a doorway and climate controlled. In addition typical chambers also receive water from conduits 14 of a watering system 16 used to water plants 18 that are grown within the chamber 12. The plants 18 can be of any type, whether leafy, growing from a stalk, growing underground or the like and includes, but is not limited to corn, tomatoes, lettuce, swiss chard, alfalfa, broccoli, spinach, potatoes, strawberries, cannabis, flowers and the like. In addition to conduits 14 from a watering system 16 the chamber also has a lighting system 20.

The lighting system 20 includes a plurality of lighting devices 22 that are electrically connected to an electrical system of the facility 10 and are hung or mounted to the ceiling or structure within the chamber 12 that positions the lighting devices above the plants 18 and illuminates the chamber 12 as is known in the art.

Each lighting device 22 has a housing 24 that includes a heat sink 26 secured to a substrate 28 that contains a driving circuitry 30 and a plurality of light emitting diodes 32 wherein the substrate 28 engages the substrate to convey heat created by the driving circuitry 30 to the heat sink. The LEDs can emit any wavelength of light, visible or otherwise, including but not limited to ultra violet, violet, blue, green, yellow, orange red, infrared or the like selected to enhance growth of the plant. A lens element 34 is secured to the housing 24 in a manner to create a water tight seal to prevent the ingress of water to the substrate 28 as is known in the art. The lens element 34 similarly diffuses light in order to provide light to the plants 18 within the chamber 12.

First and second openings 36 and 38 are disposed through the heat sink 26 of the housing in parallel spaced relation and extending the entire length of the housing 24 from a first end 40 to a second end 42. A conduit 44 is disposed through the openings 36 and 38 to provide a fluid flow path through the housing 24. The conduit 44 engages the heat sink 26 of the housing 24 such that heat is conveyed from the heat sink through the conduit 44 to heat any fluid or water flowing therethrough.

The conduit 44 is made of any material and can be of single piece or multi-piece construction. In one embodiment the conduit 44 is a flexible hose of one piece construction that extends from the first end 40 through the first opening 36, exiting at the second end 42 and bending into a c-shaped section 46. The hose then extends back into the housing 24 through the second opening 38 at the second end 42 and extends through the housing 24 exiting at the housing 24 at the first end 40. Optionally a second lighting device 22 can be aligned and secured to a first lighting device 22 such that the openings 36 and 38 of each device align with one another. In this manner the conduit 44 is disposed through both the first and second lighting devices 22. The devices 22 can also be spaced apart from one another with the conduit extending between the devices and through the housing 24 of each device.

An engine 48 is fluidly connected to the conduit for pumping water through the conduit 44. The engine 48 and conduit 44 are fluidly connected to the watering system 16 such that water is supplied to the engine 48 and pumped through the conduit 44 and thus through the lighting devices 22. The conduit 44 of the lighting devices 22 are also fluidly connected to a tank 50 that is located remote or outside of the incubation chamber 12. The tank 50 in one embodiment is a hot water heater and holds heated water for use within the facility 10.

In operation when the lighting devices 22 are operating the engine 48 pumps cold water through the conduit 44. As the water is conveyed through individual lighting devices 22 heat is conveyed from the circuitry 30 of the lighting device 22 to the heat sink 26 and into the water. The water gains more and more heat until conveyed from within the chamber 12 and to the tank 50 where it is stored as hot water for use throughout the rest of the facility 10.

Thus provided is a lighting system 20 that utilizes water to convey heat produced by individual lighting devices 22 from the devices 22 inside of an incubation chamber 12 where plants 18 are grown to an environment outside the incubation chamber 12. The water is then heated or cooled and able to be reused in any manner needed. Consequently, the amount of heat that is expelled into the incubation chamber 12 is minimized, minimizing the amount of climate control needed to account for the heat generated. Consequently costs are eliminated making for a more efficient overall horticultural operation. Thus, at the very least all of the stated objects have been met.

What is claimed:

1. A lighting system for horticultural lighting comprising:
an incubation chamber housing a plurality of plants grown in the chamber;
a lighting device within the chamber and positioned to provide light to the plurality of plants;
said lighting device having a housing with a heatsink secured to a substrate that has at least one lighting element thereon;
said heat sink having first and second openings disposed therethrough;
a conduit disposed through the first and second openings to provide a fluid flow path through the housing used to convey heat from the heat sink through the conduit.

2. The lighting system of claim 1 wherein the conduit is a flexible hose.

3. The lighting system of claim 1 wherein the conduit is of multi-piece construction.

4. The lighting system of claim 1 wherein water conveys heat from the heat though through the conduit.

5. The lighting system of claim 1 wherein the system further comprises:
an engine fluidly connected to the conduit for pumping water through the conduit.

6. The lighting system of claim 5 further comprises:
a tank fluidly connected to the conduit to provide the water.
